(19) United States
(12) Patent Application Publication
(10) Pub. No.: US 2004/0207113 A1
(43) Pub. Date: Oct. 21, 2004

(54) Method for manufacturing coated products

(75) Inventor: Jan Wietze Huisman, Bellingwolde (NL)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Vertis B.V.

(21) Appl. No.: 10/809,017

(22) Filed: Mar. 25, 2004

Related U.S. Application Data
(63) Continuation of application No. 09/869,532, filed on Aug. 30, 2001, now abandoned.
Application No. 09/869,532 is a 371 of international application No. PCT/NL99/00818, filed on Dec. 29, 1999.

(30) Foreign Application Priority Data
Dec. 29, 1998 (NL) 1010915
Dec. 29, 1998 (NL) 1010916

(51) Int. Cl. B29C 45/00

(52) U.S. Cl. 264/255; 264/309; 264/328.1

(57) ABSTRACT

A method for manufacturing products with a coating, wherein from at least one mass comprising at least natural polymers, a base product is manufactured, while to at least one part of the product, a coating is applied, a coating being used having a surface tension which is approximately equal to or preferably lower than the surface tension of a portion of the mass, at least of the or each relevant part of the base product to which the coating is applied.

The invention relates to a method for manufacturing coated products. The invention particularly relates to such method for manufacturing products from a mass comprising at least natural polymers.

Manufacturing products from masses containing natural polymers is known from practice and is, for instance, used for the manufacture of containers, plates and the like. This involves a mass being pressed to form a product of the desired shape, whereupon a coating is applied to at least a part of the product. Such products have as an advantage that they may be completely or largely biodegradable, which is favorable from an environmental point of view. It has been found that the bonding of the coating to the skin of the product and the cohesion of the coating are often insufficient for obtaining a product having a sufficiently resistant coating, as a consequence of which the properties of the relevant product in different applications are insufficient, in particular for instance the water and vapor proofness, the flexibility, the resistance to chemicals, the lifetime and the like.

U.S. Pat. No. 5,683,772 discloses a method for producing articles from a mass containing starch. Mold releasing agents are used in said mass, such as stearates silicones and waxes. A coating can be applied to the surface of said article to alter surface characteristics, such as sealing. Coating as applied in a single layer, covering the complete surface.

The object of the invention is to provide a method of the type described in the preamble, in which the drawbacks mentioned are avoided while the advantages thereof are retained. To that end, a method according to the present invention is characterized by the features of claim 1.

Surprisingly, it has been found that the properties of a product manufactured by such method have improved considerably over the known products. Without wishing to be linked up to any theory, it is assumed that this effect is realized in that a better flow of the coating over the basic product part to be coated is effected in that the angle of contact between drops of coating and the surface of the base product is reduced due to the relevant surface tensions. As a result, the drops of coating will flow more effectively, in particular flow together more effectively to form a film layer, and moreover exhibit a better bonding to the mass of the base product. Thus, there is obtained on the relevant part of the base product a film layer of coating exhibiting a particularly good bonding and a particularly good internal connection, so that a closed coating is obtained and maintained having particularly good properties. Thus, with a method according to the present invention, a product can be obtained having a coating which is, for instance, vapor proof and flexible, which can follow deformations of the product, for instance at pivoting parts or during expansion, shrinkage or compression of the product, and which moreover retains these properties for a long time.

Applying a coating to a portion of a base product will in many cases result in a change of the properties of the relevant base product part. In this manner, for instance the flexibility of the relevant part can thus be increased or decreased, or the brittleness thereof can be influenced, the resistance to water, vapor or other substances can be increased or decreased and the like. Through the use of different coatings, a different product property on different base product parts can be influenced, or, conversely, such influencing can be prevented. By applying different coatings so as to overlap at least partially, product parts can readily be protected against influencing, while, on the other hand, the properties of other product parts can in fact be influenced. Moreover, by overlapping coatings, the properties of the relevant coatings can be influenced as well, for instance through chemical interaction of components from the different coatings and/or the mass.

Surprisingly, it has been found that the use of a mass having a relatively high surface tension is acceptable in this respect, in spite of the relatively slight resistance thereof to liquids, in particular water, because the well bonding coating removes these drawbacks and leads to a product having said particularly good properties. As a matter of fact, base products having relatively low surface tensions are also well applicable, provided that coatings adapted thereto be used.

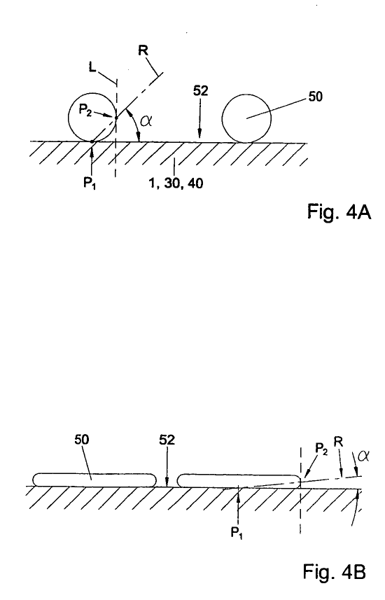

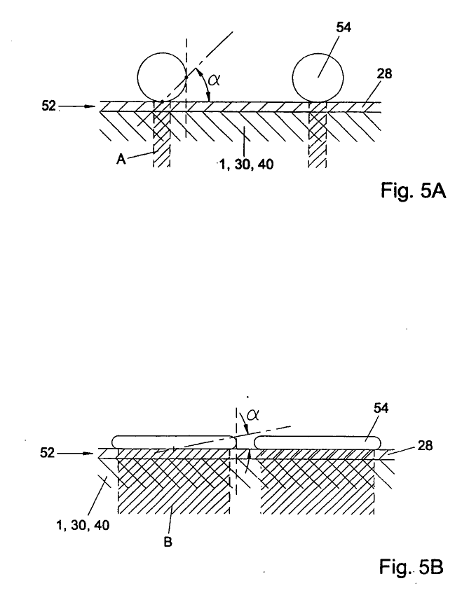

In this context, “angle of contact” is defined as described with reference to FIGS. 4A, B and FIGS. 5A, B.

A base product according to the present invention is preferably formed under increased pressure and/or temperature in a mold.

In a particularly advantageous embodiment, a method according to the present invention is characterized by the features of claim 5.

The use of detaching agents, normally also referred to as release agents, in the at least one mass offers the advantage that products can successively be manufactured in a mold which products may, for instance, comprise parts which are hard to clear. The advantage achieved through the use of an amount of release agent, egressing from the mass, such that on the wall of the mold there is obtained a layer of release agent of a substantially constant thickness, is that on the one hand, the wall of the mold is prevented from becoming too rough (which occurs when too little release agent is used), as a consequence of which the products would adhere to the wall of the mold or at least could often not be removed therefrom without damage, in particular due to fouling of the mold by mass remaining behind therein, which mass could moreover burn. On the other hand, the effect achieved hereby is that it prevents the situation that too much release agent remains behind in the mold, as a consequence of which the mold wall would become too smooth, resulting in undesired flow paths of the mass, irregularities in the surface of the base product, undesired cell formations within the product and the like. Moreover, a method according to invention prevents the necessity of using expensive and complicated molds, for instance bronze, anodized, teflonized or otherwise surface-treated molds. Further, this prevents the necessity of periodically introducing release agent into the mold or removing it therefrom.

In a further, particularly advantageous embodiment, a method according to the invention is characterized by the features of claim 8.

By using a mass whereby a product is obtained having a surface tension of less than about 40 dyne/cm, the product will readily clear from the mold. A product having a surface tension higher than about 30 dyne/cm can properly be coated with a water-based coating whose surface tension has been adjusted, in particular adjusted through the use of alcohols, in particular isopropyl alcohol, or silicones. Preferably, a water-based coating having a surface tension between about 40 and 27 dyne/cm is used.

Preferably, in methods according to the present invention, products are manufactured, at least base products are used, having a moisture content of less than 3 weight percents. Thus, stable, form-retaining base products are obtained that can readily be coated. Next, preferably by means of the coating, moisture is introduced into the product, while the amount of moisture fed can be regulated particularly effectively. Accordingly, the properties of the coated products can be regulated in a particularly good and simple manner.

Preferably, in water-based coatings for use in a method according to the present invention, agents for adjusting the surface tension are used which are entirely miscible with the water phase or soluble therein, and which involve the occurrence of relatively few micelles. Micelle formation, which may for instance occur during the use of soaps and the like, leads to the effect that substantially no, or at least insufficient reduction of the surface tension occurs, at least locally.

The use of a silicones-containing or comparable oily substance as release agent offers the advantage that in a particularly suitable manner, a film of release agent can be obtained in the mold, while excessive foaming therein can readily be prevented. Thus, products can be obtained which have, for instance, a smooth surface, a closed skin and which are particularly suitable for applying the desired coating.

It has been found that the use of relatively little release agent in the mass leads to advantageous products. In particular when about 0.2 wt. % of release agent is included into the mass, there is readily obtained a situation of equilibrium as regards the layer of release agent present in the mold, in particular when an oily, fatty or oil- or fat-containing release agent is used.

In alternative embodiments, in a method according to the present invention, soap or soapy products, wax or waxy products or combinations thereof are used as release agent.

As described, with a method according to the present invention, a particularly good bonding of the coating to the product can be effected. This means that the addition of surface tension-increasing agents to the mass can be acceptable and even advantageous, and that thus, an even better bonding of the coating can be realized, while coatings can be used having relatively less low surface tensions, and products having the desired properties can be obtained.

Adding a surface tension-reducing fluid to the coating offers the advantage that a coating can be used which in itself, i.e. prior to the addition of said fluid, has a relatively high surface tension, while a particularly good bonding and a coating of particularly good properties is obtained all the same, due to the relatively low surface tension during the application of the coating. Further, a coating film can thus be obtained having good properties, in particular a low surface tension and a good, relatively long-lasting density.

The use of an alcohol or alcoholic fluid as surface tension-reducing fluid offers the advantage that in a simple manner, a coating, at least coating agent, of a particularly low surface tension can be obtained. In particular the use of isopropyl alcohol or a fluid containing isopropyl alcohol is advantageous for this.

The addition of relatively much surface tension-reducing agent to the coating may yield particularly suitable properties, in that the desired difference in surface tension between the at least one coating and the base product can thus be obtained.

Advantageous coatings are, inter alia, based on the polymers represented in claims 12 and 13.

An alternative embodiment of a method according to the present invention for obtaining products with product parts having different properties is characterized by the features of claim 17.

The use of two different masses for the formation of base products offers the advantage that for different base product parts, the product properties such as the surface tension can readily be selected, for instance depending on the desired properties of the relevant base product part and/or the coatings. In addition, other properties of product parts can likewise be adjusted in this manner, for instance different densities, hardnesses, flexibilities, color, composition, fiber content, filler content and the like.

The use of spraying or atomizing techniques for applying the at least one coating to at least a part of the base product offers the advantage that in a simple manner, a layer of coating can be realized on different products, regardless of the outward appearance thereof. Particularly due to the surface tension of the coating to the applied, which is preferably lower than the surface tension of the base product to which it is to be applied, such techniques can be used in that in a simple manner, flowing of thus resulting drops on the base product will be obtained.

In an alternative embodiment, a method according to the present invention is characterized by the features of claim 26.

In such method, to be referred to as “immersion technique”, coating is applied by filling the product at least partially with coating or immersing it therein, to subsequently cause the coating to flow out of and/or from said product, such that a film of coating remains behind. Thus, in a particularly simple manner, coating can be applied, while the chance of failures of the equipment used therefor is nil. Moreover, a particularly high efficiency of the coating and little waste is thus obtained, since no coating is wasted.

The invention further relates to a method according to claim 27.

The advantage achieved by applying the at least one coating to a base product part after an agent has been provided thereon or therein which influences the product properties of the relevant part, is that the agent can thus be at least partially enclosed and retained in the relevant part. Thus, for instance the use of a softener enclosed by a coating in the relevant product part has the advantage that, as a result, the flexibility thereof can be influenced, in particular increased, permanently, at least for a long time. Conversely, it is of course also possible to withdraw softener, in particular water, from a base product part prior to the application of the coating, in order to obtain and maintain, for instance, rigidity or brittleness thereof.

In a further alternative embodiment, a method according to the invention is characterized by the features of claim 30.

The use of such coating containing an agent which influences the product properties offers the advantage that thus, said agent can be introduced into a base product part simultaneously with the application of the coating.

The invention further relates to a method according to claim 33. Through the provision of an agent which reduces the surface tension of the coating as layer after drying, an additionally good moisture resistance is obtained. Moreover, this will usually involve an increase of the smoothness of the coating, in particular when silicone oil or the like is used.

The invention further relates to the use of a release agent, characterized by the features of claim 38. The invention further relates to a product manufactured by a method according to the present invention. In addition, the invention relates to a coating, in particular suitable for use in a method according to the invention, in particular characterized by the features according to any one of claims 44-45, and to a mass for manufacturing base products suitable for use in a method according to the present invention.

Further advantageous embodiments of a method, product, use, coating and mass are given in the subclaims and will be further specified in the following description and examples. In the drawings:

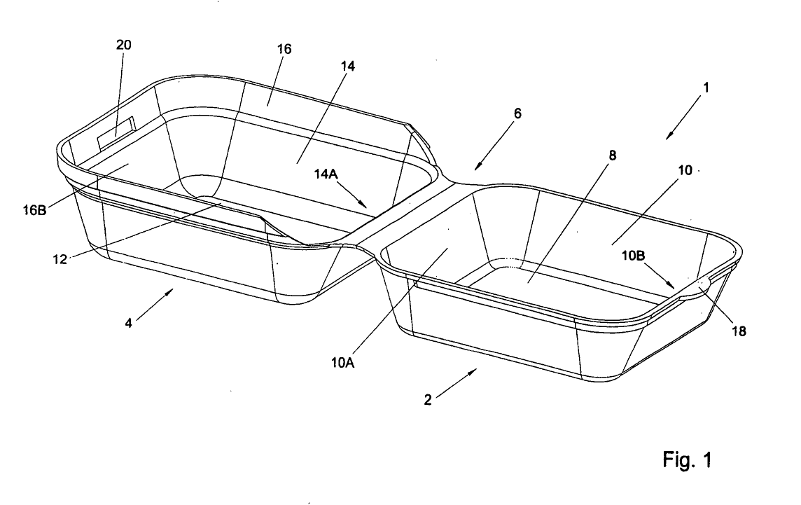

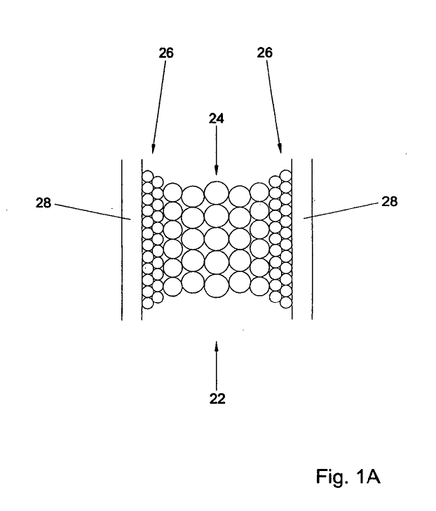

FIG. 1 shows a package, in particular a so-called clam shell as hamburger package, manufactured with a method according to the present invention;

FIG. 1A schematically shows a cross section of a wall of a product according to the invention;

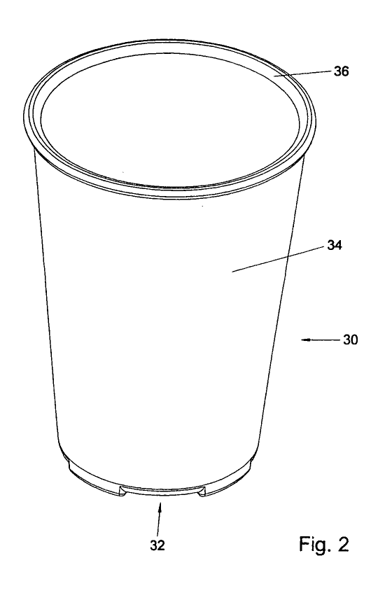

FIG. 2 shows a frustoconical container in the form of a coffee cup, manufactured with a method according to the present invention;

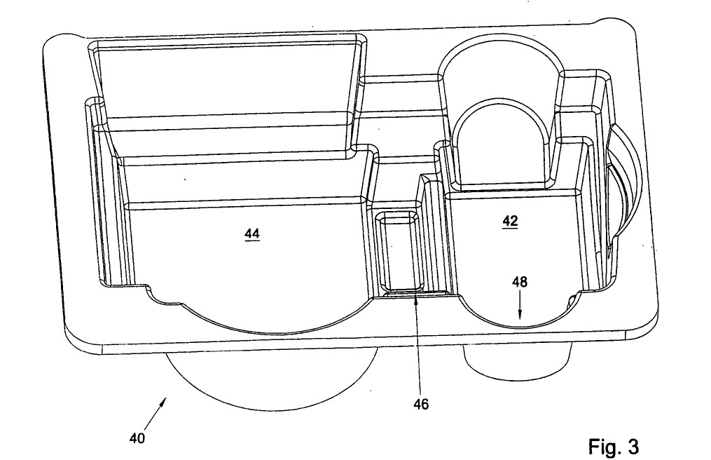

FIG. 3 shows a portion of a package, in particular an inner package for packing products, manufactured with a method according to the present invention;

FIG. 4A schematically shows drops of coating having a relatively high surface tension on a surface having a relatively low surface tension;

FIG. 4B schematically shows drops of coating having a relatively low surface tension on a surface having a relatively high surface tension;

FIG. 5A schematically shows drops, for instance water drops, having a relatively high surface tension on a coating layer having a relatively low surface tension;

FIG. 5B shows the same water drops on a coating having a relatively high surface tension;

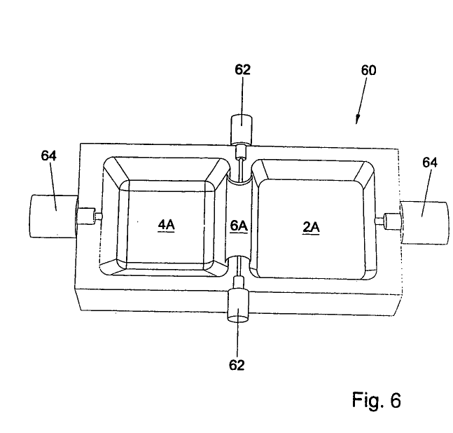

FIG. 6 schematically shows a female mold part for the formation of a container according to FIG. 1 from at least two masses;

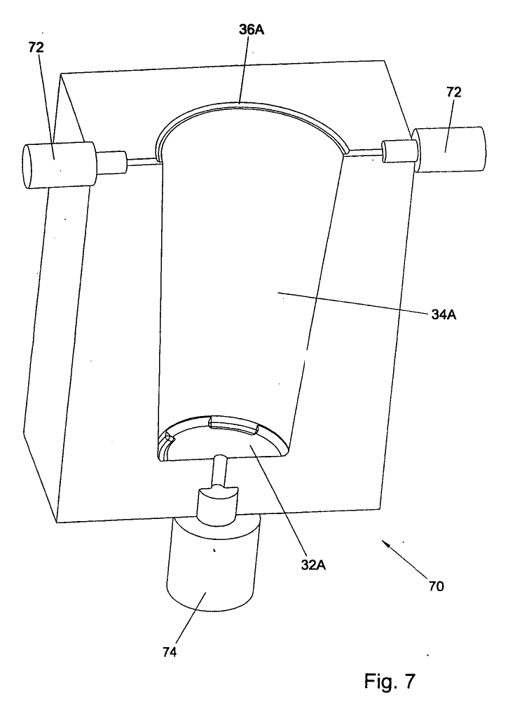

FIG. 7 shows a portion of a female mold for the formation of a cup according to FIG. 2 from at least two masses;

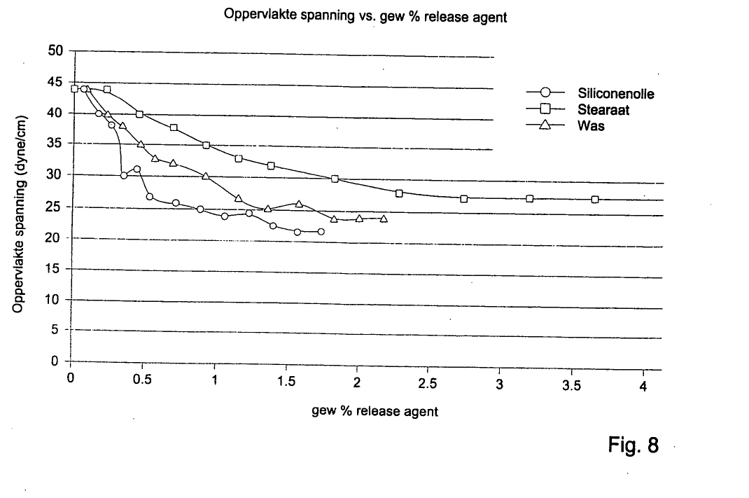

FIG. 8 shows the connection between the surface tension of a product and the amount of release agent included therein;

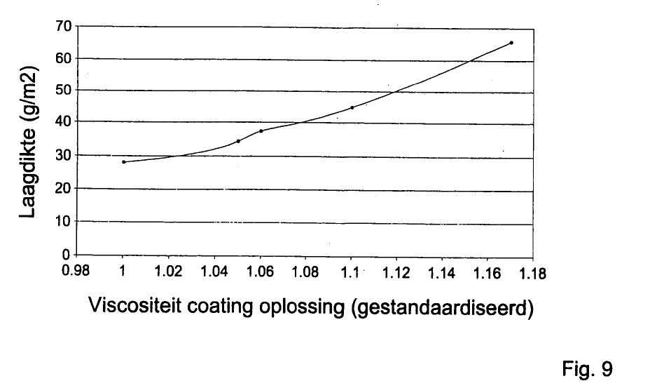

FIG. 9 is a graphic representation of the connection between layer thickness and viscosity of coatings;

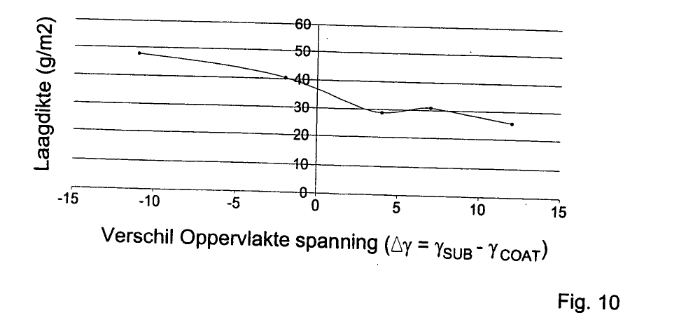

FIG. 10 is a graphic representation of the connection between the layer thickness of the coating and the difference in surface tension between the coating and a product; and

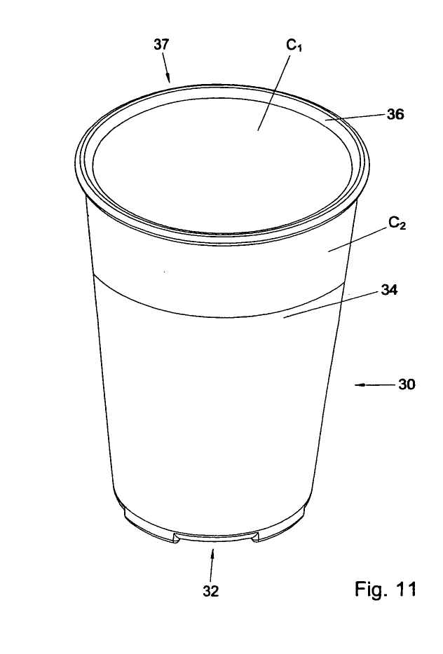

FIG. 11 shows a cup coated in an alternative manner.

FIG. 1 shows, in open top plan view, a container 1 according to the invention, manufactured as a fast-food container, which is usually referred to as, for instance, clam shell. This container 1 comprises a bottom part 2 and a cover part 4, interconnected by a hinge part 6. The container 1 is manufactured by injection molding or compression molding, utilizing baking molds. These techniques will be discussed in more detail hereinbelow.

The bottom part 2 has a bottom 8 and outwardly inclined bottom longitudinal wall parts 10 extending therefrom. The cover part 4 has a top face 12 and outwardly inclined cover longitudinal wall parts 14 extending therefrom. The hinge part 6 connects a bottom longitudinal wall part 10a to an adjacent cover longitudinal wall part 14a. Provided along the other three cover longitudinal wall parts 14, along the free longitudinal edge thereof, is a closing edge 16 which, when the container 1 is closed, falls partially over the bottom longitudinal wall parts 10. The bottom longitudinal wall part 10b opposite the hinge part 6 is provided with an outwardly extending lip 18 which, when the container 1 is closed, can be received in a recess 20 provided in the closing edge 16 opposite the hinge part 6. The hinge part 6, the lip 18 and the closing edge 6 are integrally formed with the bottom part 2 and the cover part 4 and all have a blown, foamy wall structure, as shown schematically in cross section in FIG. 1A. The wall 22 has a core 24 of relatively large cells having, on either side thereof, a relatively compact skin 26 of relatively small cells. If so desired, fibers may moreover be provided. Such product is, for instance, described in international patent application PCT/NL96/00377, to be further mentioned hereinbelow and incorporated herein by reference. In FIG. 1A, a coating layer 28 is shown on either side of the wall 22. However, it will be understood that a coating 28 may also be provided on only one side of the wall 22, while there may also be provided several layers of coating on one or both sides, as will be described in more detail hereinbelow. For products manufactured according to the present invention, it generally applies that it is advantageous to coat them on one side if the product is used at relatively high temperatures, with the coating being applied on the side facing the high temperature. In this manner, moisture, in particular water, can egress via the uncoated side, so that softening is prevented or at least limited. In the case of relatively cold use, coating should preferably be effected on two sides, to prevent condensation of moisture on and ingress of the moisture into the base product and to keep the product sufficiently stiff. Surprisingly, it has been found that for products according to the invention, it applies that when a softener, such as water, is incorporated therein, the temperature sensitivity increases to the effect that the product becomes weaker already at lower temperatures. A container according to FIG. 1 is preferably completely biodegradable, thermally relatively well insulating, manufactured from materials allowed by the American FDA and, moreover, preferably relatively well resistant to at least water, fat and/or oil and raised temperature, as may result when used as fast-food container. However, this only serves as an example and containers may be designed in other manners, with other properties, depending on the desired field of application, as will be discussed, inter alia, with reference to the examples.

FIG. 2 is a perspective, schematic view of a cup 30 according to the invention, comprising a bottom 32 and, extending therefrom, a slightly outwardly inclined longitudinal wall 34, which is provided, on the free longitudinal edge remote from the bottom, with a slightly projecting rim 36.

FIG. 3 is a perspective top plan view of a package part, in the shown embodiment for packing a telephone. In the description, this will be referred to as telephone tray 40. The telephone tray has two receiving cavities 42, 44, interconnected by a recess 46 and surrounded by an irregularly shaped longitudinal wall 48. The product is substantially relatively thin-walled, but may, for instance, be provided with thickenings or the like for obtaining additional firmness. Preferably, the cup according to FIG. 2 and the telephone tray according to FIG. 3 likewise have a wall whose cross section is comparable with that of FIG. 1A and are formed by injection molding or compression molding. However, it is also possible to manufacture such products from, for instance, pressed paper.

FIG. 4A schematically shows two coating drops 50 on the surface 52 of one of the products shown in FIGS. 1-3. The drops 50 have a surface tension which is relatively high compared with the surface tension of the surface 52 of the product 1, 30, 40. The angle of contact α is defined by the angle enclosed by a line R extending through the point of contact P1, at least the center of the contact face between the drop 50 and the surface 52, and the point of contact of the drop 50 on a line L, extending at right angles to the surface 52, with said surface 52.

FIG. 4B schematically shows a comparable situation where the drops 50 have a surface tension which is relatively low compared with the surface tension of the surface 52. As appears from a comparison between FIG. 4A and FIG. 4B, the angle of contact α becomes smaller according as the surface tension of the drops 50 becomes lower relative to the surface tension of the surface 52. As appears from FIG. 4B, at a small angle of contact α, a good covering of the surface 52 is obtained by the coating (drops) 50, which will eventually flow together to form a film if the surface tension of the drops is sufficiently low.

FIG. 5A shows a surface 52 to which a coating 28 has been applied. On the coating, two water drops 54 are schematically shown, which drops have a surface tension which is relatively high compared with the surface tension of the coating 28. Hence, the angle of contact α is relatively great. As appears from the relatively closely hatched face A under each drop, moisture, should it be able to pass the coating, will enter into a relatively small part of the product 1, 30, 40 only. This renders a product having a coating according to FIG. 5A relatively well resistant to moisture, even when the coating 28 is relatively porous. Of course, the water resistance is increased when a dense coating 28 is used.

FIG. 5B again shows a product 1, 30, 40 with a coating 28 on the surface 52, on which drops 54 are shown having a surface tension which is relatively low compared with the surface tension of the coating 28. Hence, the angle of contact α is relatively small, while the surface B over which moisture will ingress through the coating into the product is relatively large. This means that a product designed according to FIG. 5B is relatively poorly resistant to moisture from the outside.

It will be understood that in the situation shown in FIG. 5A, moisture in the product 1, 30, 40 will hardly be able to egress through the coating 28, while in the situation shown in FIG. 5B, moisture can readily disappear from the product 1, 30, 40 to the surroundings. In particular when moisture is used as softener for obtaining an increased flexibility, it is advantageous when it is retained in the product, at least in a portion thereof, such as, for instance, a hinge part. In such use, it is preferred that the relevant product part be designed as shown in FIG. 5A, while prior to or during coating, moisture is introduced into the relevant part or is retained therein.

FIG. 6 schematically shows a female mold half 60 for manufacturing the container according to FIG. 1 by injection molding from at least two masses. For this purpose, on either side of the mold half part 6a forming the hinge part 6, there is provided a first injector 62 for a mass. The injection directions of the two first injectors are widthwise in respect of the hinge part. Second injectors 64 for a second mass are provided in such a manner that they respectively open into the mold part 2a forming the bottom part 2 and into the mold part 4a forming the cover part 4, opposite the mold part 6a which forms the hinge part. During use of such a mold, for instance, a first mass is introduced into the hinge-forming part 6a by means of the first injectors 62, whereupon a second mass is injected into the bottom part-forming part 2a and the cover part-forming part 4a respectively by means of the second injectors 64, such that at the longitudinal edges of the hinge part-forming part 6a, the two masses fuse together. The first and the second mass preferably provide for different properties. In particular, a relatively flexible hinge part is formed from the first mass, possibly in cooperation with the or each coating 28 to be applied thereto, while the bottom part 2 and cover part 4 will be formed so as to be relatively stiff, again possibly in cooperation with the or each coating 28 to be applied thereto. Of course, the position where the masses fuse together may also be chosen to be different, while, moreover, several masses may be used as well, for instance different masses for the bottom part and the cover part, again for obtaining different properties. Also, the same mass may be introduced by the different injectors, yet at, for instance, different injection pressures, for obtaining other product properties.

FIG. 7 schematically shows a part of a female mold half 70 for forming a cup according to FIG. 2, with first injectors 72 opening into the part 36a which forms the rim 36, while a second injector 74 opens into the center of the mold part 32a which forms the bottom 32. Thus, different masses can be used for the rim 36 on the one hand and the bottom and the longitudinal wall 34 on the other, comparable with the manner as described with reference to FIG. 6.

It will be understood that by means of the molds of the type as shown in FIGS. 6 and 7, other properties of product parts can also be adjusted, for instance density, flexibility, hardness, brittleness, color and optionally even taste and smell. Also, the surface properties thereof can be adjusted, for instance in smoothness, surface tension and the like.

In particular during the formation of packaging products, as shown in FIG. 3, it is advantageous when the outer surface of the product is smooth, in that this will involve, during use, little friction between the inner package and, for instance, an outer box or intermediate packages, which would prevent wear. Moreover, it is advantageous when the products for coating have a relatively smooth surface, enabling them to be cleared from the mold in a simple manner, also in the case of relatively complicated molds or relatively small clearance angles. For this, the use of release agents, such as silicone oil, stearate or wax, is advantageous. The use of such release agents will, however, cause the surface tension to decrease according as more thereof is used. FIG. 8 graphically shows the connection between the surface tension and the percentage of release agent in the mass from which the product is formed. Surprisingly, it has been found that in particular when less than 1.5 weight percent of the content of dry substance is used, in particular at about 0.2 weight percent of the dry substance in the mass, optimal or at least particularly satisfactory results can be achieved.

Wherever surface tension-reducing agents are mentioned in this specification, use is made, for instance, of isopropyl alcohol having a surface tension of 21.7 dyne/cm, ethyl alcohol having a surface tension of 22.75 dyne/cm, ethyl acetate having a surface tension of 23.9 dyne/cm and, possibly, silicone solutions. The values mentioned are measured at a temperature of 20° C. For comparison, the surface tension of the mains water used was 75 dyne/cm.

In the specification and the Figures, identical or corresponding parts have identical or corresponding reference numerals. The exemplary embodiments shown of products are given as example only and should in no way be construed as being limitative.

In the following description and the examples, surface tensions of substrates are started from, i.e. of the base products measured by means of the Arco Oberflächentechnik GmbH test. The surface tensions of the coatings and other fluids are measured by a tensiometer (Krüss, type K6). The bonding of the coating was tested experimentally by sticking a strip of tape (Scotchtape, 3M) of a width of 2 cm on the product over a length of 2 cm and by subsequently pulling it loose, in one fluent movement. After that, the tape and the product were visually inspected to establish whether any coating had come off with the tape and to what extent. According as less coating came off with the tape, the bonding was considered to be better.

In the examples described hereinbelow, use is made of a number of base recipes for masses from which the base products are formed. These will be cited in the product examples by reference to Roman numerals I-XI. In so far as injection molding techniques are used, reference is made, as an example, to international patent applications PCT/NL96/00377 and PCT/NL96/00136, which, at least for this purpose, are understood to be incorporated herein by reference. Similarly, use can be made of extrusion techniques described in said patent applications and of other, comparable techniques. In so far as baking molds or platen sets are mentioned in this patent application, for forming products according to the invention, international patent applications PCT/NL95/00083 and PCT/NL95/00296 are referred to as example, which patent applications, at least for this purpose, are understood to be incorporated herein by reference.

Compared with, for instance, compression molding, i.e. forming in platen sets or the like, the use of injection molding offers the major advantage that no “baking spot” is formed. A baking spot is formed in that, during for instance compression molding, the mass is introduced into a hot mold before the platen set employed is closed. This causes, inter alia, some degree of drying and gelatinization of the mass at the contact face between the mass and the mold. That contact face is usually referred to as “baking spot”. On such baking spot, the surface tension is higher, often for instance about 4 dyne/cm higher, and the wall is more porous than in the rest of the product. This is in particular disadvantageous when an even coating layer of uniform thickness is desired, because on the baking spot, a stronger flow will occur and, accordingly, a smaller layer thickness. Moreover, this causes too great a difference in the surface tension of product and coating, for instance a difference of more than 10 dyne/cm. Further, solvent such as water of water-based coatings will soak more into the porous surface of the baking spot than into the adjoining surface and will act there as softener, which leads to weakening of the wall of the product at that location. This weakness will remain, since the coating will be watertight, at least liquidtight. In particular during heating, for instance when hot articles or liquids are introduced into the product, this weakening leads to malfunctioning of the product.

Unless indicated otherwise, for applying the coatings, a High Volume Low Pressure (HVLP) spraying device of the type Walter Pilot 93-ND, an airless spraying device of the type Nordson 64B, or the immersion technique mentioned and described hereinabove is used. For each example, the technique employed is mentioned.

The use of an airless spraying device offers the advantage that a particularly effective, taut distribution of the coating is obtained, usually referred to as “coating-knife”. This prevents the formation of drops of coating on the product surface, which drops flow together to form one layer. This means that a coating can be used whose surface tension differs only little from the surface tension of the product, while a good covering is nevertheless obtained. Moreover, less coating loss occurs.

In the examples described of masses used, use is made of, inter alia, the components given in Table 1:

TABLE 1

| Mass components: | Supplier: |
|---|---|
| silicone HY oil | OSI benelux |
| hydrocarb 95T | SA Omaya |
| china clay spec | Caldic chemie |
| hydoxyapatite | Merck |
| xanthan gum | Danby food ingredients |
| guar gum | Pomona b.v. |
| cellulose | Spencer Chemie |
| impregnated cellulose | Spencer Chemie |
| viscose | Spencer Chemie |
| hemp | Spencer Chemie |
| dicera 10102 | Paramelt |
| calcium stearate | Riedel de Haan |
| solvitose | Avebe |
| starch P10X | Avebe |
| glycerol | Merck |
| cartasol K-RL | Clariant |
| sodium bicarbonate | Merck |
| dextrin | Merck |
| polyethylene glycol | Merck |

In the coating examples described, use is made of, inter alia, the components given in Table 2:

TABLE 2

| | Composition: | Supplier: |
|---|---|---|
| CAP482.5 | Cellulose acetate | Eastman Chemical |
| | propionate | |
| CAP504.2 | Cellulose acetate | Eastman Chemical |
| | propionate | |
| HTI5800M | Ammonium zirconium | Hopton Technologies |
| | carbonate | |
| HTI9880M | Zirconium acetate | Hopton Technologies |
| HTI9102M | Synthetic wax | Hopton Technologies |
| HTI9102rp | Paraffinless synt.wax | Hopton |
| | | Technologies** |
| IP12 | Isopropyl alcohol | Exachem |
| ET1 | Ethyl alcohol | Exachem |
| Aquacer498 | Synthetic wax | Byk-Cera |
| Aquacer507 | Anionic PE-wax | Byk Cera |
| 97% hydr.PVA/L | Polyvinyl alcohol | Merck |
| 50% hydr.PVA/L | Polyvinyl alcohol | Merck |
| DVL9012.0.41 | Acrylate binder | Akzo Nobel |
| GH052 | * | P.P.G. |
| Urecoll S. | Urea formaldehyde | BASF |

For GH052, a patent has been applied for by or at least on behalf of P.P.G., which patent application is understood to be incorporated herein by reference.
**HTI9102rp is a variant of the synthetic wax HTI9102M, which contains no paraffin and is fully repulpable. For the rest, this variant is applicable in exactly the same manner as HTI9102M, with the same results.

### DESCRIPTION OF THE MASSES USED

Mass I was prepared as follows. 1000 g of potato starch (foodgrade; AVEBE) was introduced into a Hobart mixer and to this, 140 g of china clay spec, 140 g of hydrocarb. 95 T, 2 g of hydroxyapatite, 2 g of xanthan gum (Ketrol F), 8 g of guar gum and 120 g of cellulose (white; about 2.5 mm) were added, with stirring at low speed (position 1). After these components were added, stirring took place for another 15 minutes at the position mentioned. Next, this mixture was introduced into a priorly measured and stirred composition of 1500 ml of mains water and 2.8 g of silicone oil HY. All components were then stirred (position 2) to form a liquid mass.

A base product manufactured from mass I has a surface tension of about 36 dyne/cm.

Mass II was prepared like mass I, but instead of 2.8 g of silicone oil HY, 10.0 g of calcium stearate was added, admixed with the other dry substance, prior to being added to the water.

A base product manufactured from mass II has a surface tension of about 37 dyne/cm.

Mass III was prepared in the manner as described for mass II. However, 7 g of Dicera 10102 was added to the dry substance instead of the stearate of mass II.

A base product manufactured from mass III has a surface tension of about 34 dyne/cm.

Mass IV was prepared by mixing 5 g of dicera wax 10102, 10 g of calcium stearate, 1000 g of potato starch, 150 g of china clay spec, 150 g of hydrocarb.95T, 2 g of hydroxyapatite, 8 g of guar gum, 2 g of xanthan gum and 120 g of cellulose fiber (white) of about 2.5 mm, at low speed, as described earlier, whereupon this mass was mixed with 1400 ml of mains water, with the addition of sodium hydroxide solution, 1M to a pH of about 9.5.

A base product manufactured from mass IV has a surface tension of about 34 dyne/cm.

Mass V was prepared like mass IV, with, moreover, the addition of cross-linker, in the form of 30 g of urea formaldehyde. A base product manufactured from mass V likewise has a surface tension of about 34 dyne/cm. The addition of the cross-linker results in a base product which is stronger and better resistant to water.

Mass VI was prepared by mixing 1000 g of potato starch in the above-described manner with 140 g of china clay spec, 140 g of hydrocarb.95T, 2 g of hydroxyapatite, 2 g of xanthan gum, 8 g of guar gum and 120 g of cellulose fibers, white, of about 2.5 mm. This was mixed with 1500 ml of mains water, to form a liquid mass.

A base product manufactured from mass VI has a surface tension of about 40 dyne/cm.

With this mass VI, base products are manufactured without release agent in a mold having adjusted inner walls, such as a teflonized aluminum mold.

Mass VII was prepared as follows. 1000 g of potato starch was mixed with 120 g of impregnated cellulose fiber, of about 2.5 mm, 20 g of calcium stearate, 75 g of china clay spec, 40 g of solvitose binder, 75 g of hydrocarb.95T, 2 g of hydroxyapatite, 2 g of xanthan gum, 8 g of guar gum and 120 g of viscose fiber, of about 8 mm. This was stirred with 1650 ml of mains water, as described earlier, to form a liquid mash.

In this mass VII, in particular suitable for use for industrial packages, a relatively large amount of fiber is incorporated. Since such packages should have a high resistance to vibrations and shocks, a coating is applied. The surface tension seems to be substantially determined by the stearate. The surface tension of a base product manufactured from mass VII is about 32 dyne/cm.

Mass VIII was prepared as follows. 250 g of starch derivative PLOX was mixed with 750 g of potato starch, while in the above-described manner, 5 g of dicera 10102, 10 g of calcium stearate, 2 g of xanthan gum, 8 g of guar gum and 120 g of cellulose fiber, white of about 2.5 mm were added thereto. This was mixed with 1400 ml of mains water.

A base product manufactured from mass VIII has a surface tension of about 34 dyne/cm.

Mass VIII is an example of a mass which is in particular suitable for more technical applications, in which, for reasons of complete incineration after use of the product, little or no filler is present. The chosen combination of wax and stearate provides for sufficient clearance, while, moreover, a favorable surface tension is obtained.

Mass IX was prepared by mixing 1000 g of potato starch in the above-described manner with 2 g of hydroxyapatite, 75 g of china clay spec, 75 g of hydrocarb.95T, 2 g of xanthan gum, 8 g of guar gum and cellulose fiber (white) of about 2.5 mm. This was mixed with 1500 ml of mains water and stirred to form a liquid mass. From this, 100 g was taken, which was subsequently mixed with 15 g of glycerol and 4 g of polyethylene glycol. A base product manufactured from mass IX had a surface tension of 44 dyne/cm.

Mass X was prepared by mixing 1000 g of potato starch in the above-described manner with 2 g of hydroxyapatite, 75 g of china clay spec, 75 g of hydrocarb.95T, 2 g of xanthan gum, 8 g of guar gum and 120 g of cellulose fiber (white) of about 2.5 mm. This was mixed with 1500 ml of mains water to which 2.8 g of silicone oil HY was added, and stirred to form a liquid mass. A base product manufactured from mass X had a surface tension of 36 dyne/cm.

Mass XI was prepared by mixing 80 g of silicone HY oil with 40.5 kg of water in a rapid mixer. To this, 500 g of solvitose, 1500 g of white cellulose and 25 kg of starch was successively added. This mixture was stirred for 5 minutes. In addition, 2100 g of china clay spec with 2100 g of hydrocarb.95T, 156 g of xanthan gum and 187 g of guar gum were dry mixed. This mixture was added to the above-described aqueous mass with stirring both with the rapid mixer and with a grate stirrer. Next, stirring took place for another 15 minutes in order to moisten the different components properly. Finally, 1500 g of white cellulose was further added, while only the grate stirrer was used. Finally, the mass was stirred to form a smooth, liquid mass.

For masses I-V and VII-XI, it applies that products manufactured therefrom are readily clearable, because in the mold, a film of release agent is created which is and remains of relatively constant thickness and composition, also when the mold is used for a long time. Thus, fouling is prevented and a proper clearance is guaranteed.

### PRODUCT EXAMPLES WITH COATINGS

Examples 1-3 relate to the use of coatings on the basis of a solvent at least substantially other than water. Where necessary, these will further be referred to as solvent-based coatings.

### Example 1

From mass VI, a fast-food container in the form of a clam-shell was manufactured, as shown in FIG. 1. To that end, the container was injection molded by the method described in the above-mentioned international patent applications. The container has a bottom face having a length of 9 cm and a width of 8 cm. The vertical walls have a height of 3.5 cm and are directed outwards at an angle of 7 degrees. The wall thicknesses were averagely about 1.5 mm. The weight is 15.2 g. The walls of the container had a foamy structure with a relatively closed skin. Upon leaving the injection molding machine, the container hardly contains any moisture. The surface tension of the container as base product, hence without coating, is determined at 40 dyne/cm (test Arco oberflächentechnik GmbH). In this condition, the container was suspended from a gauze in a spray cabin (Walter pilot type 80).

A coating solution was prepared by dissolving 36 g of powdery CAP482.5 in 400 ml of ethyl alcohol and 200 ml of ethyl acetate, for which purpose the solution was stirred for about 5 minutes by means of a magnetic stirrer. Prior to the application to the base product, the surface tension of this coating solution is 30 dyne/cm.

The solution was transferred into the beaker of a spray gun (Walter pilot type 93-ND; High Volume, Low Pressure (HVLP)), connected to compressed air of 2.1 bar. The nozzle of the spray gun had a diameter of 1.3 mm.

First, the inner side of the product was sprayed by moving the spray along the substrate from left to right and from top to bottom. The distance between substrate and spray nozzle was about 25 cm. The coating was dried for 20 seconds in an oven (WTB binder type E28), set at 100° C. Next, the outer side was sprayed and dried in the same manner as the inner side.

This resulted in a fast-food container of 17.9 g, coated double-sidedly. After applying and drying, the coating had a surface tension of 38 dyne/cm, and the container had a WVT rate (ASTM E96) of 120 g/m²/24 h.

The coating used in Example 1 formed a hard film. This coating is in particular suitable as temporary fixing agent of the microclimate within the walls of the container. As a matter of fact, the concentration of CAP may, for instance, vary between 2 and 200 gram per liter, depending on, for instance, the desired surface tension and layer thickness.

### Example 2

In this second example, a coating similar to that of Example 1 is used. The advantage of this coating is a better repulpability and improved solubility in ethyl alcohol.

30 g of powdery CAP504.2 was dissolved in a mixture of 400 ml of ethyl alcohol and 100 ml of ethyl acetate, in the manner described hereinabove.

This coating was applied to a fast-food container according to FIG. 1, manufactured from mass VI, with a self-weight of 13.7 g and a surface tension of 40 dyne/cm. For the application of the coating, the above-mentioned HVLP device was used, at a pressure of 2.7 bar. After the coating was applied double-sidedly, it was dried in an oven at 100° C. for 20 seconds. After drying, the coating as layer had a surface tension of about 36 dyne/cm and the container had a weight of 17.0 g. The WVT rate (ASTM E96) was 140 g/m²/24 h.

Like CAP482.5, CAP504.2 forms a hard film which is in particular suitable for maintaining the microclimate in the container.

### Example 3A

From mass V, a base product in the form of a cup as shown in FIG. 2 was manufactured by injection molding, which cup had a bottom diameter of 4 cm and a wall inclining outwards by 4 degrees. The cup had a self-weight of 9.2 g and contained, directly after manufacture, hardly any moisture. As base product, the cup had a surface tension of 34 dyne/cm.

A coating was composed from 60 g of powdery CAP482.5, 666 ml of ethyl alcohol and 334 ml of ethyl acetate and was applied by filling the cup up to the rim and subsequently, after 2 seconds, emptying it into a receptacle from which the coating was sucked up. This technique of filling and emptying a cup or a like product with coating for obtaining a suitable coating layer will further also be referred to as “immersion technique” or by a comparable denotation. The cup was placed in a shaking device (LaboTech RS500) for a few seconds and shaken at 225 r.p.m. Before application, the coating had a surface tension of 32 dyne/cm.

In the same upside-down position, the cup was placed for 7 seconds above an IR radiator (Fourtec IR module, fast medium wave, 800 W). After this, the product was dry and ready for use, had a surface tension of 36 dyne/cm and a weight of 10.5 g, was coated one-sidedly and had a WVT rate of 55 g/m²/24 h. The cup had a well bonded, relatively hard coating which was reasonably vapor proof, with a WVT rate of 55 g/m²/24 h.

### Example 3B

Here, Example 3A was carried out once again, however with the use of a coating manufactured from 60 g of powdery CAP504.2, dissolved in 800 ml of ethyl alcohol and 200 ml of ethyl acetate. This resulted in a comparable cup.

### Examples 3C and 3D

Here, to the coatings as described in Examples 3A and 3B, a cross-linker (15 g of HTI 9880M and 15 g of HTI 5800M respectively) was added. This resulted in stronger, more water(vapor)proof, denser coating layers. These coatings had a WVT rate of 25 g/m²/24 h and were slightly less flexible, yet had a greater tensile strength.

Examples 4-6 relate to the use of coatings containing (synthetic) waxes.

### Example 4

In this Example, a coating was used composed from 60 vol. % of HTI9102M, 40 vol. % of IP12. Because of the reduced surface tension due to the IP12, the wax is easy to spray. In addition, this coating is readily repulpable. The coating was applied by means of an HVLP-device having a nozzle of 1.3 mm under a pressure of 2.4 bar, to a fast-food container, manufactured from mass I, of 13.5 g and having a surface tension of 36 dyne/cm. The coating was applied two-sidedly, after which the product acquired a weight of 15.7 g. The coating was dried with 500 W medium-wave infrared for 7 sec. Before applying, the coating had a surface tension of 32 dyne/cm, after drying this was 21 dyne/cm, while the WVT rate was 40 g/m²/24 h.

By drying relatively slowly and at a temperature which was not too high, a relatively well-closed film of coating could be obtained, having a good flexibility and a good bonding.

### Example 5

In this Example, a coating was composed from 60 vol. % of HTI 9102 and 40% of ET1. Due to the relatively high volume of ET1, the wax proved to be properly processable. In the manner described in Example 2, the coating was applied to a combustion cone manufactured from mass VIII with a self-weight of 0.19 g and a surface tension of 34 dyne/cm according to FIG. 2, whereupon the combustion cone was dried with air of 50° C., for 25 seconds. A combustion cone is a frustoconical cup used in radiation analysis. The cone had a height of 18 mm, a closed bottom face with a diameter of 11 mm and an open top face having a diameter of 16 mm, at an average wall thickness of 1 mm. The coating had a surface tension of 32 dyne/cm before application, of 21 dyne/cm after drying. As appeared in the various examples, the surface tension of the coatings decreased by about 2-3 dyne/cm when it was applied at a temperature of about 40-50° C. This held both for the heating of the coating and for the application thereof to warm base products. Thus, the coating was further improved. After drying, the combustion cone had a weight of 0.21 g.

The WVT rate of this coating was 20 g/m²/24 h. The coating was well flexible and bonded properly to the base product, while a reasonably good film coating was obtained.

### Example 6

A fast-food container was manufactured from mass I with a self-weight of 13.2 g and a surface tension of 35 dyne/cm. A coating was composed by mixing 60 vol. % of Aquacer 498 with 30 vol. % of IP12, while 10 vol. % of water of 50° C. was admixed to prevent flocculation and to promote the sprayability. The coating had a surface tension of 32 dyne/cm before application and was applied two-sidedly with an HVLP device with a 2.0 mm nozzle under a pressure of 2.5 bar. Next, the container was dried for 25 sec. with air of 50° C. After coating, the container had a surface tension of 40 dyne/m²/24 h. The bonding of the coating was good at a relatively good flexibility.

The coating had a fairly low WVT rate. The film-formation was good. The coating formed a fatty layer, which melts at high temperatures (>60° C.).

Examples 7-9 relate to the use of surface tension-reducing agents added to the coatings, in particular to the use of polyvinyl alcohol.

### Example 7

A fast-food container was formed from mass I with a self-weight of 13.5 g and a surface tension of 36 dyne/cm. A coating was composed by mixing 30 vol. % of IP12 and 70 vol. % of a solution of 45 g of 97% hydrolyzed PVA dissolved in 1000 ml of mains water of 80° C. This coating with a surface tension of 34 dyne/cm was two-sidedly applied with an airless spraying device with pre-atomizer and a 06/20 nozzle under a pressure of 130 bar, after which the coating was dried with air of 60° C. for 40 sec. After that, the container had a self-weight of 17.6 g with a coating having a surface tension of 38 dyne/cm and a WVT rate of 40 g/m²/24 h. The coating was well flexible and well bonded.

### Example 8

A fast-food container according to FIG. 1 was injection molded from mass I with a self-weight of 13.5 g and a surface tension of 36 dyne/cm.

In one of the manners described, a coating was composed from 30 vol. % of IP12 and 70 vol. % of a solution of 100 g of 50% hydrolyzed PVA in 1000 ml of mains water of 80° C. This coating had an inherent surface tension of 34 dyne/cm, but by heating, it became about 3 dyne/cm lower, as it held for any coating used that the surface tension could be slightly reduced through heating.

The coating was applied double-sidedly with an HVLP device with a 2.0 mm nozzle, at a pressure of 3.5 bar. Next, the coating was dried for 40 sec. with air of 60° C., so that the coating acquired a surface tension of 37 dyne/cm and a WVT rate of 60 g/m²/24 h. After coating, the container weighed 16.9 g. The bonding was relatively good, the film formation and the flexibility were very good. The coating could be processed more easily than the coating of Example 7.

### Example 9

A fast-food container as in Example 8 was sprayed double-sidedly in the manner described therein with a coating according to Example 8, to which, however, 20 vol. % of Aquacer 507 was added. This coating had a surface tension of 32 dyne/cm before application and of 39 dyne/cm after drying, with a WVT rate of 47 g/m²/24 h.

This coating has a good WVT rate. The film formation is good, and the processability has improved compared with Example 8. The flexibility is excellent, which renders this coating suitable for products having movable parts which have to be resistant to water vapor, the more so because due to the added wax, the water vapor proofness had increased substantially.

Examples 10-16 relate to the use of coatings with water as main solvent, based on acrylic binders. Examples 13-16 relate to such coatings with synthetic waxes.

### Example 10

In the case of IP 12, it applies that the viscosity of the mixture first increases slowly, but very fast at higher percentages. Usually, percentages of IP 12 higher than 10% are not worked with. Surprisingly, it has been found that higher percentages render the coating suitable for obtaining the desired surface tension. The addition of extra warm water proved to be necessary for making the coating sufficiently sprayable, at least with HVLP.

To a fast-food container manufactured from mass VI with a self-weight of 16.0 g and a surface tension of 40 dyne/cm, a coating was applied double-sidedly by means of an HVLP device with a 2.0 mm nozzle and a pressure of 2.2 bar. The coating was composed from 50 vol. % of DVL9012.0.41, 35 vol. % of IP 12 and 15 vol. % of mains water of 50° C. The coating as solution had a surface tension of 35 dyne/cm. During application of the coating, the container absorbed 1.4 g of water. The coating was dried for 25 sec. with air of 60° C. and, after that, had a weight of 18.8 g, a surface tension of 20 dyne/cm and a WVT rate of 40 g/m²/24 h. The well bonding and film-forming coating was particularly flexible.

This coating has a good WVT rate, although during application, relatively much water ends up in the substrate, as a consequence of which the product becomes heavier, and cannot stand temperatures higher than about 60° C. particularly well. However, the flexibility of this coating is excellent, it does not break or tear upon movement or pivoting of product parts relative to adjoining product parts.

### Example 11

A combustion cone as described in Example 5 was manufactured from mass VIII, with a self-weight of 0.19 g and a surface tension of 34 dyne/cm before coating. A coating was composed from 60 vol. % of DVL9012.0.41 and 40 vol. % of ET 1, which is considerably higher than the volume percentages of less than 10% that are usually used for coating. By using relatively much ET 1, a coating was obtained having a surface tension of 32 dyne/cm before application. The coating was applied two-sidedly by using the method described in Example 5, further referred to as immersion technique, whereupon the combustion cone was dried for 25 sec. with air of 60° C. During coating, the cone as base product did not absorb any water. The surface tension of the coating after drying was 20 dyne/cm and the WVT rate was 35 g/m²/24 h, while the cone weighed 0.21 g. Hence, this coating had a good WVT rate, while during application, much less water was absorbed in the cone than in Example 10. Thus, the product was better resistant to relatively high temperatures, i.e. in particular to temperatures above 60° C. The flexibility of this coating remained excellent, it did not break or tear upon pivoting or movement of product parts relative to adjoining product parts.

### Example 12

A fast-food container according to FIG. 1 was manufactured from mass I, with a self-weight of 12.8 g and a surface tension of 36 dyne/cm.

A coating was prepared by mixing 600 ml of DVL9012.0.41 with 400 ml of IP 12 in the above-described manner by means of a stirring machine (Heidolph RZR2041). The surface tension of this coating was, before application, 32 dyne/cm. The solution was transferred into the reservoir of an airless injection molding machine (Nordson airless system, type 64B, pump 1:30) which was connected to a working pressure of 3 bar compressed air, resulting in a pressure of 90 bar in the nozzle, type cross-cut 0.03/16.

In the manner described hereinabove, the coating was applied two-sidedly, whereupon the coating was dried for 20 sec. with hot air of about 60° C., by means of a dryer (Ferrari 700 W). During coating, the fast-food container absorbed 0.4 g of water, while after coating, the fast-food container weighed 14.7 g. After drying, the coating had a surface tension of 18 dyne/cm and a WVT rate of 25 g/m²/24 h. This coating had a very good WVT rate, while, moreover, both the film formation and the bonding were good. Moreover, this coating had a flexibility comparable with that of the coating obtained according to Examples 10 and 11.

### Example 13

A cup according to FIG. 2 was manufactured from mass IV, with a self-weight of 9.4 g and a surface tension of 33 dyne/cm.

A coating was manufactured by mixing 40 vol. % of DVL9012.0.41, 25 vol. % of Aquacer 507 and 30 vol. % of IPA with 5 vol. % of mains water of 50° C. By means of the immersion technique, the coating was applied one-sidedly. Before application, the coating had a surface tension of 32 dyne/cm and after drying, for 25 sec. with air of 60° C., it had a surface tension of 39 dyne/cm and a WVT rate of 34 g/m²/24 h. After coating, the container had a self-weight of 10.7 g and during coating it absorbed 0.7 g of water.

This coating had a good WVT rate, while during application, still relatively much water ended up in the base product, as a result of which the cup became relatively heavy and was less properly resistant to relatively high temperatures. The flexibility of this coating remains very good during use.

### Example 14

A fast-food container was manufactured from mass VI, with a self-weight of 15.5 g and a surface tension of 40 dyne/cm. A coating was composed from 40 vol. % of DVL9012.0.41, 15 vol. % of HTI 9102, 30 vol. % of IP 12 and 15 vol. % of water of 50° C. This coating was applied to the container double-sidedly by means of an HVLP device with 2.0 mm nozzle and a working pressure of 2.2 bar. The coating was dried for 25 sec. with air of 60° C. Before application, the coating had a surface tension of 35 dyne/cm, after drying it had a surface tension of 22 dyne/cm and a WVT rate of 30 g/m²/24 h. During coating, the cup absorbed 1.3 g of water, while after coating, the container had a weight of 18.5 g. The product according to this example was comparable with a product according to Example 10, while synthetic wax was added for increasing the water vapor proofness thereof. Although this coating had a good WVT rate, relatively much water was absorbed during coating. This effect was at least partially overcome by drying relatively calmly. During use, the coating remained well flexible.

### Example 15

A fast-food container was manufactured from mass I, with a self-weight of 13.5 g and a surface tension of 36 dyne/cm. A coating was composed from 50 vol. % of DVL9012.0.41, 15 vol. % of HTI 9102 and 35 vol. % of IP 12. This coating had a surface tension of 32 dyne/cm. By means of an airless device with nozzle 0.03/10, the coating was applied two-sidedly at a pressure of 80 bar, and dried for 25 sec. with air of 60° C. During coating, the container absorbed 0.4 g of water, so that a weight of 16.5 g was obtained. After drying, the coating had a surface tension of 22 dyne/cm and a WVT rate of 26 g/m²/24 h.

This coating had a very good WVT rate. By drying relatively calmly, a good film formation was obtained. During use, the coating remained well flexible and bonded well to the base product.

### Example 16

A coffee cup according to FIG. 2 was manufactured from mass IV, with a self-weight of 9.3 g and a surface tension of 34 dyne/cm.

A coating was composed from 45 vol. % of DVL9012.0.41, 23 vol. % of Aquacer 498, 30 vol. % of IP 12 and 2 vol. % of water of 50° C. Before application, this coating had a surface tension of 34 dyne/cm. By means of an airless spraying device, the coating was atomized onto the product, with a 0.03/10 nozzle at a pressure of 70 bar. Next, the coating was dried by infrared radiation, medium wave, 500 W for 10 sec. During coating, the cup absorbed 0.5 g of water, so that after coating, the cup weighed 10.2 g. After drying, the surface tension of the coating was 36 dyne/cm, at a WVT rate of 40 g/m²/24 h. This coating, too, had a good WVT rate. The water absorption during coating was reasonable. It has been found that the water absorption can be further reduced by preparing the coating without water, yet this complicates the spraying and atomizing of the coating, due to the high viscosity thereof. This coating had a good flexibility, good bonding and good film formation.

Examples 17-22 relate to water-based coatings to which no or only very little surface tension-reducing agent was added. Examples 20-22 relate to such coatings wherein synthetic waxes were incorporated.

### Example 17

A fast-food container was manufactured from mass VI, with a self-weight of 15.2 g. It had a surface tension of 40 dyne/cm. A coating was obtained by using 100 vol. % of GH052. This coating was applied double-sidedly by means of an HVLP device with a 2.0 mm nozzle at a pressure of 2 bar. Next, the coating was dried for 45 sec. with air of 60° C. Before application, the coating had a surface tension of 38 dyne/cm, after drying it had a surface tension of 42 dyne/cm and a WVT rate of 80 g/m²/24 h. During coating, the container absorbed 2.0 g of water, so that after drying, the container weighed 18.1 g.

A coating had a reasonable WVT rate and absorbed relatively much water during coating. Thus, in particular thin-walled products coated with such coating can stand heat relatively poorly. The coating has as an advantage that it dries to become particularly firm and flexible, so that products with such coating prove to be particularly rigid and strong. This coating is in itself relatively porous, but provides for additional firmness of the container.

### Example 18

A tray for packing a telephone, as shown in FIG. 3, was manufactured from mass VII. It had a self-weight of 68.4 g and a surface tension, before coating, of 32 dyne/cm.

A coating was composed from 80 vol. % of GH 052 and 20 vol. % of IP 12. This coating was applied to the tray on all sides with an HVLP spraying device with a 1.3 mm nozzle at a pressure of 2.4 bar. Next, the coating was dried for 45 sec. with air of 60° C. During coating, the tray absorbed 3.2 g of water, while the weight of the tray, after drying, was 78.2 g. Before application, the coating had a surface tension of 31 dyne/cm, after drying it had a surface tension of 42 dyne/cm and a WVT rate of 70 g/m²/24 h. Although this solution proved to be unstable, it is well processable, in particular when stirred intermittently or continuously.

Through addition of the surface tension-reducing IP 12, a coating was obtained which flattens well during application and hence provided a particularly good film formation. The coating had no particularly low WVT rate and the product absorbed relatively much water. The coating was particularly firm and rigid after drying, while sufficient flexibility was nevertheless maintained.

### Example 19

A combustion cone as in Example 5 was manufactured from mass VIII, with a self-weight of 0.19 g and a surface tension of 34 dyne/cm. A coating was composed from 80 vol. % of GH 052 and 20 vol. % of ET 1. Like the coating according to Example 18, this coating was unstable. The coating was applied with the immersion technique, whereupon the coating was dried with air of 60° C. for 45 sec. Before application, the coating had a surface tension of 31 dyne/cm and after application it had a surface tension of 42 dyne/cm and a WVT rate of 55 g/m²/24 h. During coating, the cup absorbed 0.1 g of water and after coating, the cup weighed 0.22 g.

The WVT rate of this cup was reasonable, partly due to the immersion method used. The coating dried to become particularly strong and rigid, which is advantageous when applied to a cup or like products. With this coating, in particular the bonding and the film formation were good.

### Example 20

A tray for a telephone according to FIG. 3 was manufactured from mass VII, with a self-weight of 68.3 g and a surface tension of 32 dyne/cm. A coating was composed from 70 vol. % of GH 052 and 30 vol. % of Aquacer 507. The coating was applied on all sides with an HVLP spraying device with a 2.0 mm nozzle at a pressure of 2.2 bar. Next, the coating was dried for 45 sec. with air of 60° C. Before application, the coating had a surface tension of 35 dyne/cm, after drying it had a surface tension of 40 dyne/cm and a WVT rate of 50 g/m²/24 h. During coating, the product absorbed 3.4 g of water, so that after drying, the product had a self-weight of 78.6 g.

The coating provided for a good bonding and good film formation, while the flexibility thereof was reasonable. The coating had a relatively good WVT rate. During coating, the base product absorbed relatively much water, as a result of which the resistance to heat was not particularly high. In particular when in this manner thin-walled products are manufactured, this can be considered a disadvantage. The coating dried to become particularly firm and rigid, so that the tray became more rigid and stronger, with a relatively high water-resistance, in particular in comparison with, for instance, a product manufactured according to Example 17.

### Example 21

A fast-food container according to FIG. 1 was manufactured from mass VI, with a self-weight of 15.5 g and a surface tension of 40 dyne/cm. A coating was manufactured from 70 vol. % of GH 052 and 30 vol. % of HTI 9102. The coating was applied two-sidedly by means of an HVLP spraying device with 2.0 mm nozzle, at a pressure of 2.2 bar. The container was dried for 45 sec. with air of 60° C. Before application, the coating had a surface tension of 37 dyne/cm and after drying it had a surface tension of 40 dyne/cm at a WVT rate of 45 g/m²/24 h. During coating, the coating absorbed 1.4 g of water and acquired a weight of 18.4 g.

With this coating, the film formation was not particularly good, but the bonding actually was, while the coating remained relatively flexible. The coating had a slightly better WVT rate than in Example 20 and still absorbed relatively much water during application. This coating remained advantageous, due to in particular the relatively rigid and strong layer formed around the base product by the coating, while, moreover, a good water resistance was obtained.

### Example 22

Again, a tray for a telephone was manufactured from mass VII, with a self-weight of 68.4 g and a surface tension of 33 dyne/cm. A coating was composed from 70 vol. % of GH 052 and 30 vol. % of Aquacer 498. By means of an HVLP spraying device with a nozzle of 2.0 mm, this coating was applied double-sidedly at a pressure of 2.2 bar. Before application, the coating had a surface tension of 35 dyne/cm and after drying for 45 sec. with air of 60° C., it had a surface tension of 36 dyne/cm and a WVT rate of 45 g/m²/24 h. During coating, the tray absorbed 2.9 g of water and after drying, it had a weight of 78.0 g. The water vapor proofness of the coating was relatively good, due to the synthetic wax added. However, during the application of the coating, relatively much water was yet absorbed. The coating bonded relatively well and maintained a reasonable flexibility.

With regard to the Examples, in particular Examples 17-22, it is observed that it generally applies that the surface tension of the coating can be further reduced through the addition of more volume % of IP 12 or ET, or can be increased through the addition of less thereof. However, the addition of more surface tension-reducing agent will generally result in longer production times, will be economically disadvantageous and lead to thinner layers of coating.

In an advantageous manner, possibly unstable solutions can be mixed directly before spraying, to prevent clotting.

Examples 23-28 relate to water-based coatings with cross-linkers. Examples 27 and 28 relate to such coatings with relatively little or no surface tension-reducing agent added thereto. It is observed that the coatings as mentioned and described in each of the above-described Examples, in particular 10-22, can also be combined with cross-linkers, as for instance described hereinbelow, with comparable effects.

### Example 23

A cup according to FIG. 2 was manufactured from mass IV with a self-weight of 9.6 g and a surface tension of 34 dyne/cm. A coating was composed from 56 vol. % of DVL9012.0.41, 38 vol. % of ET 1 and 6 vol. % of HTI 5800M. By the above-described immersion technique, this coating was applied single-sidedly, i.e. on the inside of the cup, and then dried for 25 sec. with air of 60° C. Before application, the coating had a surface tension of 33 dyne/cm and after drying it had a surface tension of 20 dyne/cm at a WVT rate of 22 g/m²/24 h. During coating, the cup absorbed 0.2 g of water and after drying, it had a weight of 10.1 g.

The flexibility of this coating was not particularly good. However, in particular due to the added cross-linker, the coating was relatively dense and strong. The coating had a particularly low WVT rate, while during application, hardly any water was absorbed into the cup. The coating proved to be particularly hard and strong and relatively well resistant to relatively high temperatures.

### Example 24

Again, a cup according to FIG. 2 was manufactured from mass IV, with a self-weight of 9.4 g and a surface tension of 33 dyne/cm. A coating was composed from 54 vol. % of DVL9012.0.41, 46 vol. % of IP 12 and 10 vol. % of HTI 5800M. With an airless spraying device, this coating was atomized onto the cup, on the inside thereof with a 0.03/16 nozzle at a pressure of 90 bar. Next, the cup was dried for 6 sec. with a medium wave infrared radiator of 800 W (Fourtec). Before application, the coating had a surface tension of 32 dyne/cm and after drying it had a surface tension of 18 dyne/cm at a WVT rate of 19 g/m²/24 h. During coating, the cup absorbed 0.1 g of water and after drying, the cup had a weight of 10.2 g. Since no water was added to the coating, it had a relatively high viscosity. This coating had a particularly good, low WVT rate, a high density and a high strength and hardness. This cup proved to be particularly resistant to water vapor and relatively high temperatures.

### Example 25

A fast-food container according to FIG. 1 was manufactured from mass I, with a self-weight of 13.5 g and a surface tension of 36 dyne/cm. A coating was composed from 50 vol. % of DVL9012.0.41, 30 vol. % of IP 12 and 7 vol. % of HTI 9880M, which was diluted with 13 vol. % of water of 50° C. By means of an HVLP spraying device with a 2.0 mm nozzle, the coating was applied double-sidedly to the container at a pressure of 2.5 bar and then dried for 25 sec. with air of 60° C. Before application, the coating had a surface tension of 35 dyne/cm and after drying, it had a surface tension of 20 dyne/cm, at a WVT rate of 30 g/m²/24 h. During coating, the container absorbed 1.1 g of water and after drying, it had a weight of 16.4 g.

The coating had a good WVT rate, although more water was absorbed into the product during coating than in the case of the coatings given in Examples 23 and 24. However, the flexibility of this coating is considerably better than in the examples mentioned; it did not break or rear upon movement or pivoting of product parts of the container relative to the adjoining product parts. The coating proved to be slightly less hard and strong than in said examples.

### Example 26

A fast-food container was again manufactured from mass I, with a self-weight of 13.5 g and a surface tension of 36 dyne/cm. A coating was composed from 43 vol. % of DVL9012.0.41, 19 vol. % of Aquacer 498, 28.5 vol. % of IP 12, 4.5 vol. % of water of 50° C. and 5 vol. % of HTI 5800M. This coating was applied with an HVLP spraying device with a 2.0 mm nozzle, at a pressure of 3.5 bar. The coating was applied two-sidedly and was then dried for 25 sec. with air of 60° C. Before application, the coating had a surface tension of 36 dyne/cm, as it had after drying. During application, the container absorbed 0.9 g of water, so that after drying, it had a weight of 16.4 g. The WVT rate of the coating was 25 g/m²/24 h.

The coating according to this example had a particularly good WVT rate, while relatively little water was absorbed during the application of the coating. This coating led to good film formation and bonding and proved to be particularly suitable for relatively rigid products, which had to be resistant in particular to water and water vapor.

### Example 27

A fast-food container was manufactured from mass VI with a self-weight of 15.8 g of and a surface tension of 40 dyne/cm. A coating was composed from 95 vol. % of GH052 and 5 vol. % of HTI 9880M. The coating was applied double-sidedly with an airless spraying device with a 0.06/08 nozzle, at a pressure of 95 bar and was then dried for 45 sec. with air of 60° C. Before application, the coating had a surface tension of 38 dyne/cm, after drying it had a surface tension of 42 dyne/cm at a WVT rate of 65 g/m²/24 h. During coating, the container absorbed 1.8 g of water, so that after drying, the container weighed 18.9 g.

The coating proved to have a reasonably good WVT rate. During application of the coating, the base product absorbed relatively much water, as a result of which the product was not particularly resistant to heat. This will hold in particular for thin-walled products. The already relatively high strength and firmness of this coating was slightly further improved, compared with Example 17. This coating had a good bonding at a reasonable film formation.

### Example 28

A coffee cup according to FIG. 2 was manufactured from mass VI with a self-weight of 9.4 g and a surface tension of 40 dyne/cm. A coating was composed from 64 vol. % of GH 052, 26 vol. % of HTI 9102 and 10 vol. % of HTI 5880 M. The coating was applied double-sidedly with an airless spraying device with a 0.03/10 nozzle at a pressure of 80 bar. After drying for 45 sec. with air of 60° C., the coating had a surface tension of 40 dyne/cm, while before application, this was 35 dyne/cm. The WVT rate was 40 g/m²/24 h, after drying, while the cup after drying weighed 10.6 g and had absorbed 0.5 g of water during coating.

A cup according to Example 28 had a good WVT rate, yet absorbed relatively much water during coating. Advantageous of this coating were the rigidity and strength thereof, and an increased water resistance compared with Examples 17 and 20.

Examples 29-31 relate to the combination of two different coatings, applied one over the other at least partially, or coatings built up from two components to be applied one after the other.

### Example 29

A fast-food container was manufactured from mass I, with a self-weight of 13.7 g and a surface tension of 36 dyne/cm. A first coating was manufactured and applied as described in Example 2, starting from CAP504.2, while a second coating was applied over the first one, which second coating was manufactured and applied as described in Example 12, starting from DVL9012.0.41. Before application, the first coating had a surface tension of 30 dyne/cm, the second coating had a surface tension of 32 dyne/cm. During application, the first layer actually served as primer for increasing the surface tension and as barrier to water included into the second coating. After drying, the first coating had a surface tension of 38 dyne/cm, while the surface tension of the second coating after drying was 20 dyne/cm. During coating, the product did not absorb any water, while after drying the container weighed 17.6 g, coated double-sidedly. After drying, the WVT rate of the composed coating was 8 g/m²/24 h.

The container obtained according to Example 29 was particularly water proof and dry. This product had a particularly good, low WVT rate and absorbed no water during application of the coating. This container is particularly well resistant to high temperatures, even above 90° C. The bonding of the composed coating was relatively good, the flexibility was good and the film formation was particularly good.

### Example 30

A fast-food container according to FIG. 1 was manufactured from mass I, with a self-weight of 13.5 g and a surface tension of 36 dyne/cm. A first coating was manufactured and applied in the manner as described in Example 6, after which a second coating was applied over the first coating, which second coating was composed and applied as described in Example 18. The first coating was dried before the second coating was applied. Before application, the first coating had a surface tension of 32 dyne/cm, the second coating had a surface tension of 38 dyne/cm. After drying, the first coating had a surface tension of 40 dyne/cm, like the second coating. During application of the coatings, 1.0 g of water was absorbed, while after drying, the product had a weight of 17.7 g. In this example, the first coating served as surface tension-increasing primer and as barrier to the absorption of water from the second coating. This proved to be of greater importance in a container according to Example 30 than in a container according to Example 29, since the second coating in Example 30 contains relatively much water. After drying, the composed coating had a WVT rate of 20 g/m²/24 h. Hence, this coating had a particularly good WVT rate, while relatively little water was absorbed during the application of the coating. The bonding of both the first and the second coating proved to be particularly good, so that a particularly rigid and strong, water vapor-resistant container was obtained. The flexibility of the composed coating proved not to be particularly good, but on the other hand, the film forming proved to be particularly good.

### Example 31

This concerns an example of a coating which reacts favorably with a reactive component of the base product, in the present case a cross-linker.

A fast-food container according to FIG. 1 was manufactured from mass I, with a self-weight of 13.5 g and a surface tension of 36 dyne/cm. A first coating was manufactured as described in Example 8, a second coating consisted entirely of Urecoll S.

The first coating was applied to the base product as described in Example 8, whereupon the highly reactive second coating was applied over the first coating, still wet, by means of an airless spraying device with a 0.03/16 nozzle with pre-atomizer, at a pressure of 90 bar. Next, the two coatings were dried together for 20 sec. with air of 70° C. The surface tension of the composed coating was 34 dyne/cm with a WVT rate of 30 g/m²/24 h. During coating, the product absorbed 1.1 g of water, resulting in a self-weight of the double-sidedly coated container of 16 g. This coating proved to lead to particularly good film formation with a good bonding. The coating had a particularly good WVT rate, was particularly hard and strong and little flexible.

It has been found that in particular for the second coating in this example, a very good atomization leads to advantageous results. The surface tension of the second coating proved to be of little importance, which is advantageous because less reactive cross-linkers can be used as well, which have a surface tension-increasing effect on the relevant mixture.

Optionally, the composed coating as proposed according to Example 31 can also be atomized, with the two components being joined together directly before atomization. For this purpose, a Graco Dual Mix™ device was used with success, which device was also used for spraying unstable coatings.

### Example 32

A cup according to FIG. 2 was manufactured from mass IV, with a surface tension of 33 dyne/cm and a weight of 9.4 g. A coating was composed from 60 vol. % of DVL9012.0.41, 35 vol. % of ET1 and 5 vol. % of silicone oil HY. This coating was applied to the cup double-sidedly by means of the immersion technique. Before application, the coating had a surface tension of 32 dyne/cm. After drying for 35 sec. with air of 60° C., the cup had a weight of 10.7 g, while the coating had a surface tension of 18 dyne/cm and a WVT rate of 18 g/m²/24 h. During coating, the cup absorbed 0.4 g of water.

In the coating used in this example, a surface tension-reducing agent (ET1) was added so as to reduce the surface tension of the coating as solution, while, moreover, a surface tension-reducing agent (silicone oil HY) was added for reducing the surface tension of the coating, as layer, after drying. This cup had a particularly low WVT rate and a very high vapor proofness, due to, in particular, the low surface tension of the coating. Moreover, the coating had a good bonding, good flexibility and good film-forming properties. Due to the relatively low water absorption, the cup was moreover well resistant to increased temperatures, even to above 90° C. This coating proved to have a particularly smooth surface, in particular due to the silicone oil HY included therein. Such coating, i.e. a coating including an agent for reducing the surface tension after drying, is particularly suitable for in particular improving the water and vapor proofness and the smoothness.

### Example 33

A fast-food container according to FIG. 1 was manufactured with a mold according to FIG. 6. By the first injectors 62, mass IX was introduced and by the second injectors 64, mass X was introduced. The container had a self-weight of 13.7 g before coating.

A first and a second coating were composed as given in Example 29. The first coating (surface tension 30 dyne/cm) was applied two-sidedly and dried as described in Example 2, however with the hinge part 6 covered in that the container was clamped in at that location. After drying of the first coating, the second coating (surface tension 32 dyne/cm) was applied, two-sidedly, and dried as described in Example 12. Both the first coating and the hinge part 6 were coated. Because during application of the second coating, the hinge part 6 was not protected by the at least temporarily properly water-resistant first coating (surface tension 38 dyne/cm) and the hinge part had a relatively high surface tension (44 dyne/cm), relatively much water was absorbed by the hinge part, in particular water from the second coating. Since water functions as softener, or at least as softener-reinforcing agent for the glycerol for the relevant mass, a hinge part was obtained which was particularly flexible, in particular considerably more flexible than the cover part and bottom part. After coating and drying, the container had a weight of 17.6 g, a surface tension of 20 dyne/cm and a WVT rate of 8 g/m²/24 h. During coating, the hinge part absorbed 0.3 g of water, while the bottom part and the cover part did not absorb any water.

This container had a particularly good WVT rate, while only the hinge part absorbed water during coating. As a result, the container had a particularly dry microclimate, in particular in the bottom part and the cover part, so that it was properly resistant to heat and water (vapor) proof, and a particularly flexible hinge part, while the cover part 4 and the bottom part 2 were relatively stiff, form-retaining and strongly coated. The bonding was good, in particular on the hinge part.

### Example 34

A cup according to FIG. 2 was manufactured from paper having a wall thickness of 0.3 mm, with a weight of 4.6 g and a surface tension of 41 dyne/cm. A coating was composed from 60 vol. % of DVL9012.0.41 and 40 vol. % of IP12. The coating was applied to the inner side of the cup by means of an airless spraying device with a 05005 nozzle, at a pressure of 90 bar, whereupon the coating was dried with air of 60° C. for 25 sec. After that, the cup weighed 5.1 g, while the coating layer weighed 31.8 9 g/m² and had a WVT rate of 25 g/m²/24 h. Before application, the surface tension of the coating was 31 dyne/cm, after drying it was 20 dyne/cm. During coating, the cup absorbed no water.

The cup obtained from this example had a good WVT rate, while it was well resistant to high temperatures. The coating bonded properly, as film, to the paper and was well flexible.

### Example 35

A fast-food container was manufactured as described in Example 33. However, an alternative mass IX was used, in which no glycerol was included. As a result, the softener effect in the hinge part of the container was fully provided by the water included therein.

### Example 36

A fast-food container was manufactured as described in Example 33, while, however, blue colorant was added (2 g of cartasol K-RL) to the mass for forming the cover part and the hinge part. Thus, a container of an even more pleasant appearance was obtained. Moreover, coloring offers the advantage that the distribution of the masses can be properly determined.

### Example 37

A cup according to FIG. 2 was manufactured from mass XI, with a surface tension of about 38 dyne/cm. A coating was composed from HTY9102rp, YP12 and, possibly, DVL9012.0.41, in five different ratios as given the Table 3 below.

TABLE 3

| | | Standard | Layer | Standard |
|---|---|---|---|---|
| | Viscosity (η) | deviation | thickness | deviation |
| Coating | (DINsec/η_{base}) | (η/η_{base}) | (d) (g/m²) | (d) (g/m²) |
| Base | 1 | 0.011 | 27.8 | 3.5 |
| Base-40-4 | 1.05 | 0.0058 | 32.9 | 2.8 |
| Base-40-5 | 1.06 | 0.0062 | 36.7 | 5.3 |
| Base-40-7 | 1.10 | 0.0093 | 44.3 | 4.5 |
| Base-40-13 | 1.17 | 0.0079 | 64.6 | 5.3 |

Base = 60- vol.%HTI19102rp-vol.%IP12-Ovol.%DVL9012.0.41
Base-40-4 = 56 vol.%HTI19102rp-40 vol.%IP12-4 vol.%DVL9012.0.41
Base-40-5 = 55 vol.%HTI19102rp-40 vol.%IP12-5 vol.%DVL9012.0.41
Base-40-7 = 53 vol.%HT19102rp-4-vol.%IP12-7 vol.%DVL9012.0.41
Base-40-13 = 47 vol.%HT19102rp-40 vol.%IP12-13 vol.%DVL9012.0.41

With these coatings, a coating layer was applied on the inner side of the cup by means of the above-described immersion technique. The viscosity of the coating solution was in each case varied, in particular by adding said DVL9012.0.41. This was opted for because the viscosity can thereby be varied, substantially without any other properties being influenced thereby. With each of the coatings described, a coating layer was applied whose thickness was determined afterwards by comparing the weight of the cup after coating, with the weight of the cup before coating. The results of these measurings are given in Table 3, where the second column gives a value for the viscosity of the relevant coating in relation to the coating represented in the first row, referred to as base, with a standardized viscosity of 1. FIG. 9 graphically represents the layer thickness in g/m² (vertical axis) relative to the viscosity of the coating solution (standardized; horizontal axis) represented in Table 3. As FIG. 9 clearly demonstrates, the layer thickness increases with the viscosity when use is made of the immersion method mentioned. To the cups obtained with the different coatings, it applies that these are water proof, while cups having a layer thickness of the coating of above 45 g/m² have even proved to be resistant to boiling water.

Next, a series of cups was again manufactured, coated with the immersion technique described. A first series of cups were manufactured from a mass comparable with mass XI, in which 0.24 wt. % of silicone HY-oil was used, further referred to as substrate base, while a second series of cups was manufactured with only 0.12 wt. % of silicone HY-oil, further referred to as substrate base-50. With this, as base product, cups having different surface tensions were obtained. The cups from the first series (substrate base) had a surface tension of 38 dyne/cm, the cups from the second series (substrate base-50) had a surface tension of 43 dyne/cm. Coatings were manufactured from HTI9102rp and IP12, while the concentration of IP12 was varied for influencing the surface tension. Next, five cups were coated, using different combinations of substrate and coating. Table 4 successively indicates for five combinations the type of substrate and coating, the difference in surface tension between substrate and coating, the obtained layer thickness in g/m² and the standard deviation.

TABLE 4

| | | Difference | | |
|---|---|---|---|---|
| | | in surface | Layer | Standard |
| | | tension | thickness | deviation |
| Substrate | Coating | (Δγ = γ_{sub} − γ_{coat}) | (d) (g/m²) | (d) (g/m²) |
| Base-50 | Base | 12 | 25.8 | 3.7 |
| Base | Base | 7 | 30.4 | 2.8 |
| Base | Base-33 | 4 | 27.8 | 5.7 |
| Base | Base-27 | −2 | 41.8 | 7.2 |
| Base | Base-20 | −11 | 48.1 | 3.5 |

Coating Base = 60 vol.%HTI9102rp-40 vol.%IP12
Base-33 = 67 vol.%HTI9102rp-33 vol.%IP12
Base-27 = 73 vol.%HTI9102rp-27 vol.%IP12
Base-20 = 80 vol.%HTI9102rp-20 vol.%IP12
Substrate Base = 0.24 wt.%HY oil
Base-50 = 0.12 wt.%HY oil

The coatings used had a surface tension of 31, 34, 40 and 49 dyne/cm respectively. Next, FIG. 10 graphically represents the relationship between the layer thickness (g/m²; vertical axis) and the difference in the surface tension between substrate and coating (horizontal axis). The layer thickness is again determined by measuring the difference between the coated cup and the uncoated cup.

As FIG. 10 demonstrates, it applies that when the difference in surface tension decreases, the layer thickness of the coating increases, when the immersion technique is employed. The cups obtained are all water proof, while it applies again that the products of a layer thickness above 45 g/m² are also resistant to boiling water. As a matter of fact, it is observed that for products with a difference in surface tension between substrate and coating of more than +12, the water proofness has proved to decrease considerably, as does the resistance to heat. Without wishing to be linked up to any theory, this seems to result from the relatively great difference in surface tension combined with a slightly more porous skin of the product due to the reduced content of silicone HY-oil, so that the water-based coating used in this example permeates through the skin of the product and relatively much water ends up in the inner foam.

Surprisingly, it has been found that when the immersion technique is employed, very small or even negative differences between the surface tension of the substrate and that of the coating can be used. In this context, a negative difference should be interpreted as a surface tension of the coating which is slightly higher than that of the substrate. Thus, a relatively thick layer of coating can nevertheless be obtained.

FIG. 11 shows a cup comparable with a cup according to FIG. 2, wherein the inner side is provided with a suitable coating C1, preferably a heat-resistant coating as described earlier, while on the outer side of the cup, there is likewise provided a coating C2, preferably likewise relatively heat-resistant, for instance one of the coatings as described in Example 37. In the embodiment shown in FIG. 10, however, the coating C2 is applied only to a portion of the outer surface of the cup, in particular below the upper longitudinal edge 37. The coating C2 extends, for instance, over a quarter of the height of the cup, such that the lower three quarters of the longitudinal wall 34 of the cup are uncoated at least on the outer side. This offers the advantage that the portion of the outer wall 34 of the cup which, during drinking, contacts the lips of a user is coated, which is pleasant to the user, because in that case, his or her lips will not “stick” to the cup, while said uncoated lower portion of the outer side of the longitudinal wall 34 can breathe. This means that moisture enclosed in the wall can evaporate through the skin when very hot beverages, for instance of a temperature of more than 85° C., are poured into the cup, so that the cup retains its stiffness even more effectively, also when the cup contains, for instance, boiling water. As a matter of fact, it is observed that the same effect can also be used for other products such as clam shells and the like, by coating the outer side of those products only partially.

When the immersion technique described is used, it may be advantageous that the bottom be provided with a double coating layer. This may, for instance, involve the use of a solution of 73% HTI9102rp and 27% IP12, which coating has a surface tension of about 37 dyne/cm. A first layer can be provided on the bottom with, for instance, a brush or a sponge, whereupon the layer is dried with air of 60° C. for 40 seconds. Next, with the immersion technique, a second layer of coating of the same or a different type is provided. Thus, an even better bottom is obtained.

Examples 6, 7, 8, 9, 10, 12, 15, 21, 25, 26, 29, 30 and 31 were repeated, however with the fast-food containers manufactured by means of compression molding in a platen set. This led to comparable results as far as the coatings are concerned. However, injection molding is preferred for mass production.

All examples performed with mass IV were also performed with mass V. The cross-linkers added yielded comparable results. However, a slightly greater density was obtained, while products manufactured therewith became slightly stronger and more watertight.

All coatings and masses used are manufactured from FDA-allowed materials. In particular the coatings containing HTI9102M/-rp are particularly well resistant to fat and oil, or at least fat-tight and oil-tight. The use of HTI9102rp instead of HTI9102M offers the advantage that the products are fully repulpable and can hence be incorporated in paper recycling. HTI9102 is also suitable therefor, but less so than HTI19102rp. In the examples concerned, HI9102M was replaced by HTI19102rp, with the same results.

It will be understood that the invention is in no way limited to the embodiments represented in the description, the Figures and the examples. Many variations thereof are possible within the framework of the invention as described in the associated claims.

Several layers of coating may be applied one above the other, while different coatings may moreover be used side by side for changing material properties locally. In the different coatings, compositions may be adjusted for obtaining slightly adjusted properties. This will be immediately understood by anyone skilled in the art. Combinations of the different examples, at least of products and coatings used therein, are possible. Other properties of both the base products and the coatings than those mentioned may, of course, be influenced as well, for instance through the addition to or omission of other reactive components. Also, products other than those mentioned may be manufactured in the same or comparable manners. Thus, for instance in applicant's Dutch patent application titled “Method for manufacturing products, and such products”, filed on the same day, there are described a number of examples for manufacturing products which can be coated in the manners described hereinabove. Said patent application is understood to be incorporated herein by reference.

1-47. (canceled)

48. A method for manufacturing products with a coating, wherein from at least one mass comprising at least natural polymers, a base product is manufactured, having a first coating upon one relevant part thereof, and a second coating over at least a portion of said first coating, said first coating having a surface tension which is approximately equal to or preferably lower than the surface tension of a portion of the at least one portion of the base product.

49. A method according to claim 48, wherein the base product is formed in a mold with raising of pressure and/or temperature, preferably by means of injection molding.

50. A method according to claim 48, wherein the at least one mass is introduced in or through a mold and is heated in the mold, such that at least cross-linkage of the natural polymers occurs, while surface tension-reducing agents are incorporated in the mass.

51. A method according to claim 48, wherein the at least one mass is at least substantially manufactured as paper-forming mass.

52. A method for manufacturing coated products, according to claim 48, wherein in the at least one mass, release agents are incorporated in an amount such that during heating, a portion of the release agents egresses from the mass and bonds to the wall of the mold, such that during manufacture of successive products in the same mold, a substantial constant layer of release agent always remains present.

53. A method according to claim 48, wherein as release agent, a surface tension-reducing component is added to the mass.

54. A method according to claim 48, wherein a coating is used having a surface tension of less than 42 dyne/cm (42×10⁻³ N/m), preferably less than 36 dyne/cm (36×10⁻³ N/m) and more in particular less than 32 dyne/cm (32×10⁻³ N/m).

55. A method according to claim 48, wherein a product is formed which, after leaving the molding die in which it is formed, has a surface tension of less than 44 dyne/cm and greater than 30 dyne/cm, while a coating is applied to at least a portion of the surface, said coating being water based and having a surface tension of between 40 and 27 dyne/cm.

56. A method according to claim 48, wherein the product, upon leaving the mold, has a moisture content of less than 3 wt. %, while by means of coating, moisture, in particular water, is introduced into the product.

57. A method according to claim 48, wherein the product, upon leaving the mold, has a moisture content of less than 3 wt. %, while by means of coating, moisture, in particular water, is introduced into the product.

58. A method according to claim 48, wherein as coating, a water based, one phase system is used, preferably having few micelles.

59. A method according to claim 48, wherein the at least one coating is applied to the base product at a temperature of between 20° C. and 50° C., preferably between 25° C. and 50° C., the arrangement being such that the surface tension of the coating is slightly reduced with respect to the surface tension at lower temperatures.

60. A method according to claim 48, wherein as coating, in particular as first coating, a coating is used comprising at least one component from the group consisting of melamine, acrylic binders, water-resistant lacquers, cellulose lacquers, cellulose acetate propionates, polyethylene, polyacrylates, synthetic polymers, natural polymers, synthetic waxes, natural waxes, polyactic acid, and combinations thereof.

61. A method according to claim 48, wherein as coating, in particular as second coating, a coating is used comprising at least one component from the group consisting of acrylic binders, latices, styrene-butadiene latex, polyvinyl alcohol, polyvinyl acetate, polyacrylates, polyethylene glycol, polyactic acid, synthetic polymers, natural polymers, natural waxes, synthetic waxes, for instance ionic polyethylene waxes, and combinations thereof.

62. A method according to claim 48, wherein in the coating, in particular the first and/or second coating, cross linkers are incorporated.

63. A method in accordance with claim 62, wherein the cross-linking agent is selected—from the group consisting of zirconium acetate, urea formaldehyde, melamine formaldehyde, glyoxal, ammonium zirconium carbonate, polyamideamine-epichlorohydrin, epoxides, trimetaphophate and combinations thereof.

64. A method according to claim 61, wherein in the at least one coating, at least one of the waxes is combined with at least one of the other components mentioned.

65. A method according to claim 48, wherein at least one coating is used which increases the water vapor proofness of the product.

66. A method according to claim 48, wherein at least as outer or outermost coating, and FDA-allowed coating is used.

67. A method according to claim 59, wherein at least as outer or outermost coating, a fat-resistant and/or fat-tight coating is used.

68. A method according to claim 48, wherein the at least one coating is applied to only one part of the product, the surface tension of the parts of the product that remain clear of the coating being kept or rendered lower than the surface tension of said coating.

69. A method according to claim 48, wherein the product is manufactured from at least two different masses, the surface tensions of the parts formed from the different masses preferably differing from one another.

70. A method according to claim 48, wherein the at least one coating is applied by spraying.

71. A method according to claim 48, wherein the at least one coating is applied by atomizing.

72. A method according to claim 70, wherein the at least one coating is applied by airless spraying or atomizing.

73. A method according to claim 70, wherein the at least one coating is applied by spraying or atomizing with compressed air-control.

74. A method according to claim 48, wherein the product has at least one receiving cavity, the receiving cavity being at least partially filled with fluid coating and subsequently poured empty, such that a film of coating remains behind on at least a portion of the wall of the receiving cavity.

75. A method according to claim 48, wherein on or in at least a part of the base product there is provided an agent influencing the properties of the relevant product part, prior to the application of the at least one coating to the relevant product part.

76. A method according to claim 75, wherein as said influencing agent, a softener or softener-containing gent is used.

77. A method according to claim 75, wherein as said influencing agent, water or a water-containing agent is used.

78. A method according to claim 48, wherein a coating is used comprising an agent influencing the properties of the base product, in the form of at least a softener.

79. A method according to claim 78, wherein as softener, water is used.

80. A method according to claim 78, wherein to the relevant base product part, at least one coating is applied which is denser than said agent influencing the properties of the base product.

81. A method according to claim 48, wherein a coating is used in which a surface tension-reducing agent is included which provides for a reduction of the surface tension of the coating layer after drying.

82. A method according to claim 81, wherein as surface tension-reducing agent, an oily or oil-containing product is used.

83. A method according to claim 81, wherein as surface tension-reducing agent, silicone oil is used.

84. A method according to claim 83, wherein between 0.5 and 15% of silicone oil based upon the total volume of coating composition together with silicone oil is employed.

85. A method according to claim 84, wherein between 2 and 10% of silicone oil based upon the total volume of coating composition together with silicone oil is employed.
